(19) United States
(12) Patent Application Publication
(10) Pub. No.: US 2008/0130204 A1
(43) Pub. Date: Jun. 5, 2008

(54) Device For Connecting At Least One Electrical Component, Especially Pertaining To A Motor Vehicle, To A Power Supply

(75) Inventor: Thomas Bielesch, Muhlacker (DE)

Correspondence Address: FOLEY AND LARDNER LLP;SUITE 500, 3000 K STREET NW, WASHINGTON, DC, 20007, US

(73) Assignee: BEHR GmbH & CO., KG

(21) Appl. No.: 11/629,404

(22) PCT Filed: Jun. 14, 2005
(86) PCT No.: PCT/EP05/06327

§ 371 Date: Sep. 6, 2007

(30) Foreign Application Priority Data
Jun. 14, 2004 (DE) 10 2004 028 393.1

(51) Int. Cl. G06F 1/16

(52) U.S. Cl. 361/679

(57) ABSTRACT

The invention relates to a device comprising a housing, wherein a first contact unit to which the power supply can be connected is arranged on a first side of the housing, and a second contact unit to which the electrical component can be connected is arranged on a second side of the housing. The first contact unit is connected to the second contact unit by means of at least one contact conductor, in such a way that an electrical circuit connection can be established between the power supply and the electrical component.

The present invention relates to a device for connecting at least one electrical component to a line network, in particular of a motor vehicle.

Such a connecting device, a plug-in system or plug system for connecting an (electric) drive of an electric fan, for example for a cooling system for cooling the engine of a motor vehicle or for an air conditioning system for air conditioning the passenger compartment of a motor vehicle, to an onboard power system of the motor vehicle, is known from the prior art.

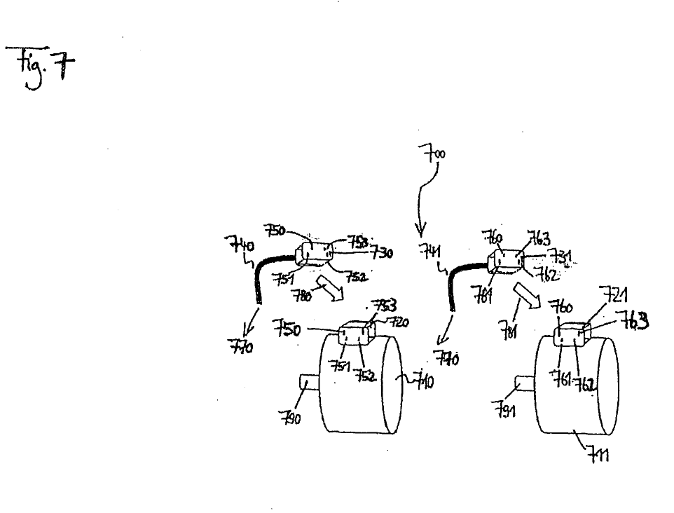

FIG. 7 illustrates such a plug-in system 780 or 781 from the prior art for a double fan system 700 of a motor vehicle cooling module.

In this double fan system 700, two electrical drive units or motors 710, 711 are each connected to an onboard power system 770 of a motor vehicle using this plug-in system 780, 781, a four-pole plug-in connection or plug connection with which contact can be made on one side, known from the prior art.

The plug-in system 780, 781 comprises two plug-in components with which contact can be made or which can be plugged one into the other, a two, three or, as illustrated by way of example, four pole onboard power system plug 730 or 731 with which contact can be made on one side, and an associated two, three or, as illustrated by way of example, four pole mating plug part 720 or 721 with which contact can also be made on one side.

The onboard power system plug 730 or 731 is connected via a cable 740 or 741 to the onboard power system 770. The mating plug part 720 or 721 is integrated into the electric drive motor 710 or 711 and into its housing in a permanent fashion, i.e. so as to not be easily detachable, inter alia by means of a solder connection, as a result of which it is a fixed, integral component of the electric drive motor 710 or 711 and the latter is connected to the mating plug 720 or 721 in accordance with the cable 740 or 741 or such a connection.

The cable 740 or 741 bundles four lines in the illustrated case, two lines serving as the main power supply, in this case (+/−)—feedlines of a battery supply.

Furthermore, two lines are control lines and bus lines, generally signal and communication signal lines, of a vehicle electronic system.

The same applies to the fixed, integrated connection between the mating plug part 720 or 721 and the respective drive motor 710 or 711.

When contact is made with the plug-in system 780 or 781 or plug parts 730 or 731 and 720 or 721 are plugged one into the other, the connection between the onboard power system and the (respective) drive 710 or 711 is produced by means of four pole contacts 750 to 753 or 760 to 763, as a result of which the drive 710 or 711 is supplied with power and control signals and communication signals.

Depending on the modulation of the respective drive, the respective drive shaft 790 or 791 is made to rotate, and said rotation is transmitted to a fan or a blower.

A disadvantage with this double fan system 700 with two drive units 710 and 711 which are connected to the onboard power system 700 via plug-in connections 780 and 781 with which contact can be made in each case on one side, is that each drive unit 710 or 711 can be contacted and actuated separately with the onboard power system 700.

As a result, the vehicle requires increased expenditure on cabling and/or mounting, usually associated with an increased space requirement, as well as a larger variety of parts as well as increased expenditure on actuation systems in terms of software and hardware with correspondingly high costs and known electrical and electronic disadvantages.

This applies in particular to overall systems which can be implemented in a compact way, such as are required particularly in the field of automobiles.

Many electrical and electronic systems such as the above fan drives are controlled by means of correspondingly complex interfaces so that a relatively high number of connection lines, in particular control lines and/or bus systems, are necessary for each fan drive here. Consequently, the corresponding cabling expenditure for the entire fan system increases correspondingly.

Furthermore, more wide ranging measures, for example in terms of software and hardware, are necessary for such more complex fan drives with additional control lines and increased expenditure on cabling, in order to decouple the individual fan drives or fan systems with respect to the communication, and also in order to be able to actuate them individually. Disadvantages in terms of diagnostic capabilities are also associated with this.

The disadvantages which occur with simple fan systems apply correspondingly to an even greater degree with relatively complex& multiple fan systems in which contact has to be made between each of a plurality of—customized—system components such as fans or fan drives and an onboard power system separately by means of the plug-in connection, with which contact can be made on one side, as in the prior art.

In this context, whenever a further system component is added it may be necessary to make new structural expenditure, in particular in order to produce the fixed, integrated connection of the plug-in part into the newly added system component. This expenditure and also increased production expenditure resulting from this is also possibly increased further if system components have to be additionally constructed and implemented with cable outgoers.

The invention is therefore based on the object of providing a plug system, generally a connection device, for connecting an electrical or electronic component such as an electric drive, a blower regulator, an electronic control device or an actuator, to a line network, which connecting device to this extent permits simple, flexible and cost effective cabling of the electrical component with low expenditure on cabling and/or mounting.

Furthermore, a modular design, composed of a plurality of electrical or electronic components, such as a plurality of fan systems and actuators, is made possible which can in particular be implemented in a compact fashion.

Furthermore, the invention is intended to avoid the above wide ranging disadvantages of relatively complex multiple systems such as fan systems, in particular in the case of multiple fan systems.

These objects are achieved by means of the device for connecting at least one electrical or electronic component to a line network, in particular a motor vehicle, having the features according to the independent patent claim.

Preferred embodiments and developments are the subject matter of the subclaims.

The device according to the invention for connecting at least one electrical component to a line network has a housing in which a first contact unit to which the line network can be connected is arranged on a first side of the housing and a second contact unit to which the electrical or electronic component can be connected is arranged on a second side of the housing.

In this context, a contact unit is understood below to be a generally functional element for making electrical contact, for example a plug contact or a plug contact element, in particular a contact pin, of a single pole or multipole plug, or else a corresponding mating element such as a contact socket for receiving of a contact pin.

This includes all the forms of a spatial embodiment/configuration of such a functional element for making contact. The contacts can be arranged here, for example, horizontally and/or vertically.

By making contact by means of such a contact unit it is possible, in particular, to implement a main current contact, for example for a current supply, or a signal contact, in particular for transmitting a communication signal, such as a control signal.

Furthermore, below a line is understood to be any type of signal line, current line and/or data line, and a line network is understood to be an associated, superordinate unit of such lines. The line network according to the invention can, for example, be a power supply network or a communications network, in particular a bus system or a control system.

The first contact unit is connected, using at least one contact conductor, for example a (metallic) flat conductor or round conductor, to the second contact unit, in such a way that an electrical line connection can be produced between the line network and the electrical component.

In terms of its appearance, the device according to the invention realizes a flexible adapter plug with which contact can be made on one side or else many sides and which can be configured from a single pole or multipole plug or adapter and which, on the basis of various electrical or electronic (E/E) basic components each with specific electrical connecting systems and customized line networks each with customized contacts and types of plug, realizes the connection of the latter to one another.

In this context, the contact between an adapter according to the invention and the E/E basic component is preferably made by means of a plug-in connection with, if appropriate, a plurality of plug-in contacts/pins in which the adapter or the plug-in contacts are plugged in a basic mating contact base, generally a plug-in socket, integrated into the E/E basic component by said adapter, generally referred to here as a second contact unit.

This plug-in connection or this connector can preferably be sealed and secured. For this purpose, for example, means by which the plug-in connection or the connection of the electrical component to the second contact unit is sealed and/or secured can be arranged, for example, partially on the second side of the housing and/or second contact unit.

The seal can preferably be configured by means of a flange connection with integrated O ring or a sealing film. The securing connection can be implemented by means of a screwed connection or a welded connection.

In one preferred embodiment, the seal and the securing connection are implemented by means of flange connection which is secured by means of an integrated groove and an O ring inserted in the groove as well as by fastening by means of a screwed connection.

The line network can be connected to the first contact unit by means of a plug connection. The line network can, for this purpose, have a contact plug or a corresponding mating element such as a contact/plug socket or a “plug-in socket” for connecting to the first contact unit. The first contact unit is then configured and adapted in accordance with the configuration of the connection to the line network, and designed for example as a plug socket for receiving a contact plug.

In one embodiment of the adapter according to the invention as a multipole plug with which contact can be made on a plurality of sides it is possible to connect a plurality of E/E components, such as an electric drive, in particular an electric motor, or an actuator, for example an expandable material element or an electronic open-loop or closed-loop control device, to one another electrically—and in a way which can be expanded in a modular fashion—both a voltage supply and, where necessary, one or more control contacts or signal and bus lines being connected by means of cable sets.

For this purpose, the housing can have, on a further, in this case third, side of the housing, a third contact unit, to which third contact unit a further or additional electrical component can be connected.

In order to produce the electrical connection to the further component, or electrical component, this third contact unit can be connected to the first and/or second contact unit, using at least one contact conductor, for example a flat conductor or round conductor, in such a way that there is an electrical connecting line between the line network and the further electrical component and/or the electrical component and the additional electrical component.

The further electrical component can then preferably be connected to the third contact unit using a plug connection. In this case, the third contact unit can be realized as part of a plug connection, in particular as a plug socket designed to receive a contact plug.

Here it is possible to provide further for the housing to have at least two such third housing sides, on each of which such a third contact unit is arranged, for connecting at least two additional electrical components.

The invention and an embodiment according to the invention as a pluggable adapter also permits a contact making direction, i.e. an insertion or plug-in direction of the adapter according to the invention into the E/E basic component, to be implemented not just analogously to the installation direction of an electronic unit into a housing but also perpendicularly thereto or counter thereto or at right angles thereto.

Furthermore, the adapter according to the invention thus permits structural variants of plugs, in particular vehicle plugs for passenger cars, sports utility vehicles, motorbikes or trucks and plug-in systems and E/E components.

For this purpose, the contact units or the sides of their housings can be oriented as desired and/or arranged with respect to one another in accordance with the installation requirements or other requirements such as space requirements.

Thus, in one development, the housing according to the invention is configured in such a way that the first contact unit and the second contact unit and/or the first contact unit and the third contact unit are oriented in a normal direction with respect to one another or opposite one another.

The housing according to the invention furthermore permits electrical insulation of the at least one line connection or of a plurality of line connections with respect to one another and protects them, and also contacts on the contact units, against environmental influences such as dampness or damage.

In a further preferred development, devices according to the invention are used for carrying out cooling and/or air conditioning, in particular of a passenger compartment of a vehicle or an engine of a vehicle, the electrical or electronic components being an electric drive, in particular an electric motor of an electric fan or air conditioning system blower.

In a further preferred development, the device is a multipole, in particular a two pole, three pole or four pole, adapter plug, in which, depending on the number of poles, a corresponding number of contacts are provided on the respective contact units and/or line connections between the contacts.

Here too, a particular degree of flexibility is obtained with the invention in terms of shape, material selection, arrangement and cross section of contacts. The design, shape, position and direction of an adapter plug configured according to the invention are determined by the invention.

Thus, for example, the invention—in an embodiment as an adapter for connecting a pipe ventilation system to an onboard power system—permits the adapter according to the invention to be inserted through an air vane of the pipe ventilation system, which is otherwise difficult owing to the small space requirement or cross section of the feed through. Since the plug-in direction can also be configured in a variable fashion according to the invention, the disadvantages of a highly integrated system as in the prior art can be eliminated here.

When a device according to the invention for connecting an electrical or electronic component to a line network, in particular of a motor vehicle, is manufactured, the contact units and the line connections are at least partially or else entirely encapsulated by injection molding, generally surrounded by a sheath or sleeve, in particular with a plastic. In this way, a (plastic) housing is easily realized.

With the device according to the invention and developments thereof, in particular as a multipole multiple adapter plug, it is possible, inter alia, to realize or achieve the following, partially already specified objects and advantages, even in combination depending on the embodiment:

Just one basic E/E component (for example E fan, drive, control device, regulator etc.) with integrated standard mating contact base is necessary in order to adapt this E/E component to a respective customized plug. That is to say the basic component can in principle be used for various customers and their plug-in systems.

As a result, the development expenditure is reduced with the component being adapted to other customers or their specific plug-in systems. All that is necessary is to adapt the adapter according to the invention. Other parameters can usually be realized by means of software adaptations.

For various basic E/E components, only one adapter is necessary per customer/specific plug-in system, and a corresponding housing feed through with corresponding standard mating plug is necessary in the component.

In principle, a plug-in system according to the invention is suitable for standardization.

Various E/E components can be connected in series, the voltage supply and actuation being provided by just one customer-end plug.

It is possible to implement single, double and multiple plugs or adapters with differently arranged plug geometries and positions.

The number of contacts used can be adapted to the application at low cost.

The contacts for the voltage supply have, for example in the case of double plugs and multiple plugs, a low contact resistance owing to the short and direct connections in the plug-in system. This reduces the losses.

This also meets the requirement to realize a functional unit.

The plug-in direction of the adapter unit is variable within wide ranges.

The fabrication of the formation of contacts in the overall system can be evaluated at relatively low costs.

Thus, a first such adapter plug can be implemented as a main connection plug to an onboard power system of a vehicle with corresponding main power feed lines and control and bus lines, which system connects a first electrical unit, the basic component, to the onboard power system.

Further drive units or subsystems such as actuators with corresponding main current lines, control lines and bus lines can be connected to the onboard power system as downstream connecting plugs or further connecting plugs by means of such adapter plugs.

The contacts for making contact with control lines and bus lines can be configured as bidirectional inputs or outputs. These can then be used as sensor inputs, bus lines or control lines for external components such as, for example, a blind or an expandable material element.

The control lines or bus lines can be used to carry out encoding for the respective drive (for example: right hand/left hand drive). Intelligent integration into a fail safe concept for a fan system with a blind can be realized.

It is possible to connect further drives to a multiconductor additional line.

In addition to the advantages described above, the device according to the invention and its developments also have the following further advantages:

All contemporary bus systems from a very wide variety of manufacturers or customers can be realized by means of an adapter plug system according to the inventive device, for example a PWM actuation means—an interface either with a terminal 15/87 or without a terminal 15/87—a CAN bus or a LIN bus system.

With just one at least four pole adapter plug according to the inventive device it is possible to use two PWM input signals to actuate two drives separately, for example for two fans.

Given corresponding configuration and software modification, the invention permits drive systems to communicate directly with one another or with the onboard power system (electronics of the vehicle).

A second adapter plug according to the invention, for example on a second drive unit, can, where necessary, also be used only on one side (for connecting to the first inventive adapter plug which is used on both sides on the first drive unit). In this context, the second adapter plug side can be enclosed with plastic or be fitted with a blind plug.

Furthermore, the invention can be used to perform thermal management of a module and of a fan system by integrating software into the drives.

Contacts of the input plug or main adapter plug can, compared to contacts of the output plug or further connecting adapter plug, be connected to different drive inputs or drive outputs so that they can be actuated or read independently of one another.

Furthermore, the invention allows protection systems, such as an antiblocking protection, a fail safe mode and/or diagnostics—here as a diagnostics plug or as a diagnostics contact—to be integrated into the drive.

Further advantages, features and application possibilities of the present invention emerge from the subsequent description of exemplary embodiments in conjunction with the figures, of which:

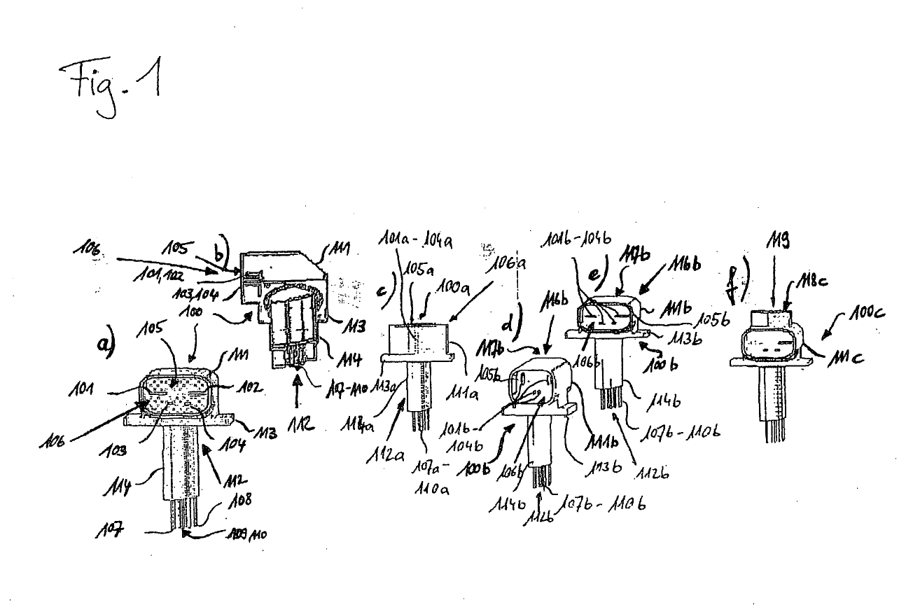

FIGS. 1a to f are outlines of various embodiments of a connection adapter according to the invention;

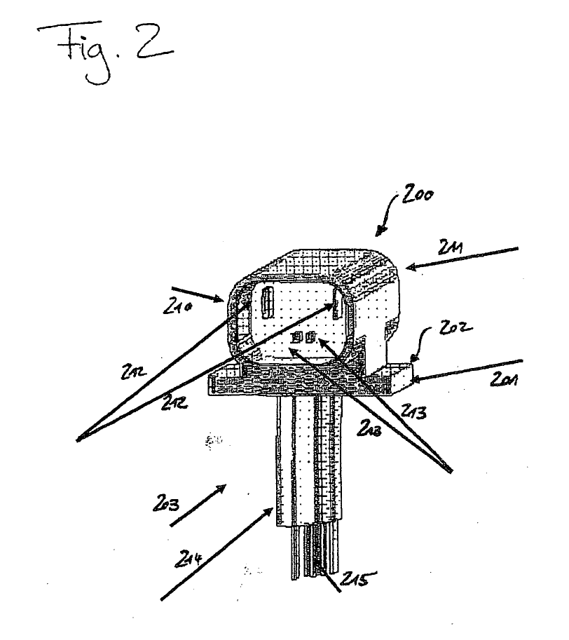

FIG. 2 is an outline of a 4 pole connection adapter with vertically arranged contacts for connecting a basic E/E component and a further E/E component to an onboard power system of a vehicle according to a first exemplary embodiment according to the invention;

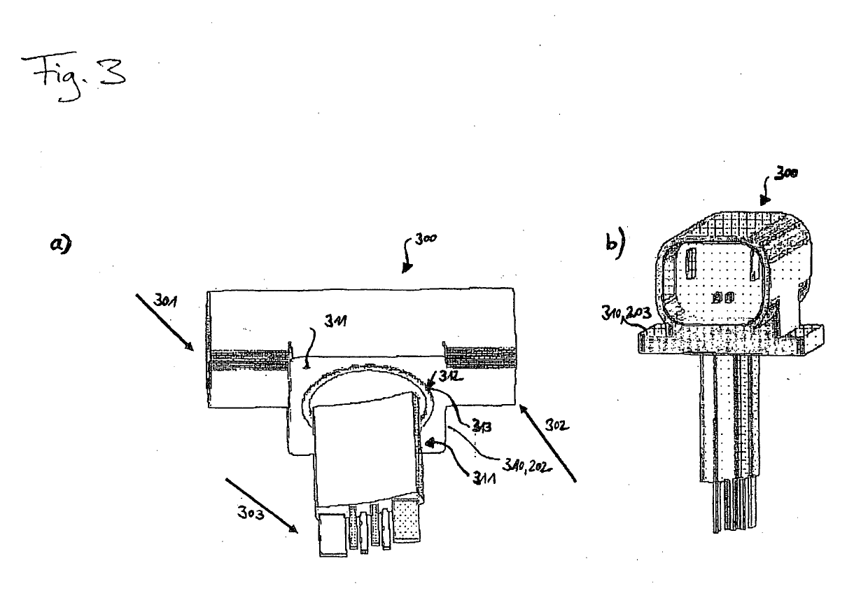

FIGS. 3a and b are outlines of a 4 pole connection adapter with vertically arranged contacts for connecting a basic E/E component and a further E/E component to a vehicle onboard power system according to a first exemplary embodiment;

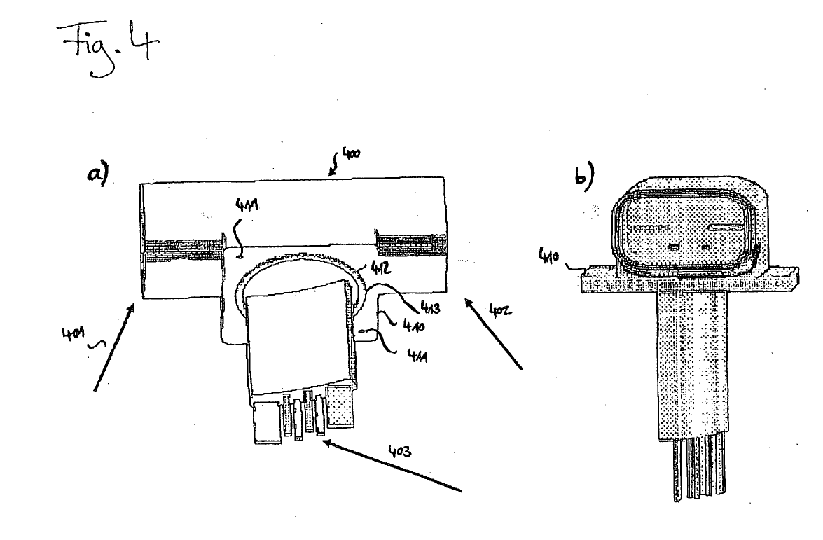

FIGS. 4a and b are outlines of a 4 pole connection adapter with horizontally arranged contacts for connecting a basic E/E component and a further E/E component to an onboard power system of a vehicle according to a second exemplary embodiment according to the invention;

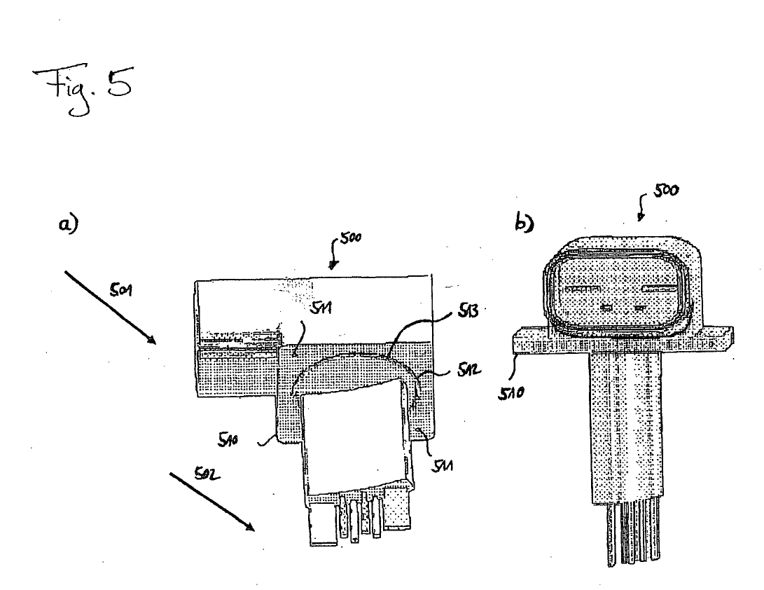

FIGS. 5a and b are outlines of a 4 pole connection adapter for connecting a basic E/E component to an onboard power system of a vehicle according to a third exemplary embodiment according to the invention;

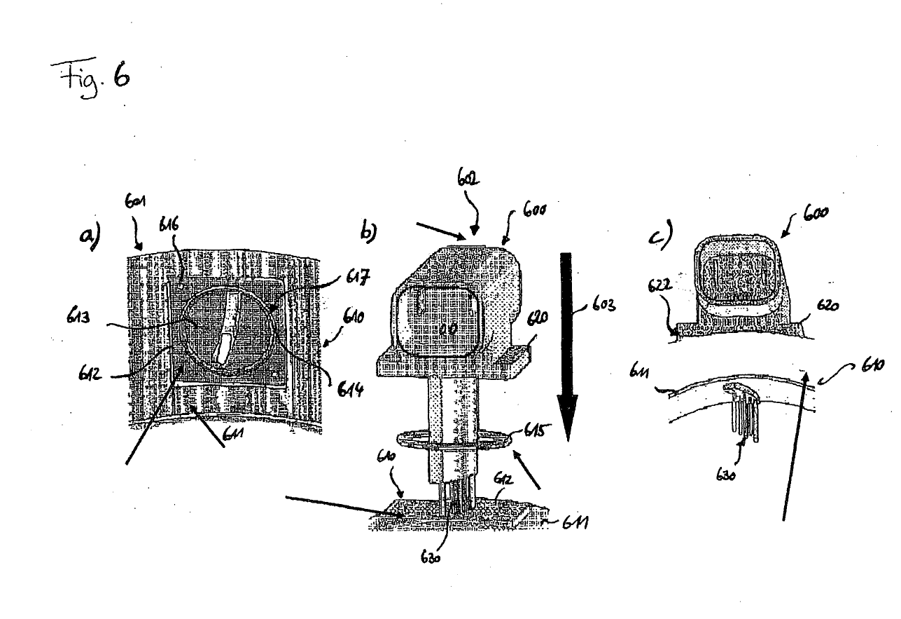

FIGS. 6a to c are outlines showing the mounting of an adapter according to the invention in a basic component;

FIG. 7 is an outline of a double fan system with plug-in connections with which contact can be made on one side, according to the prior art;

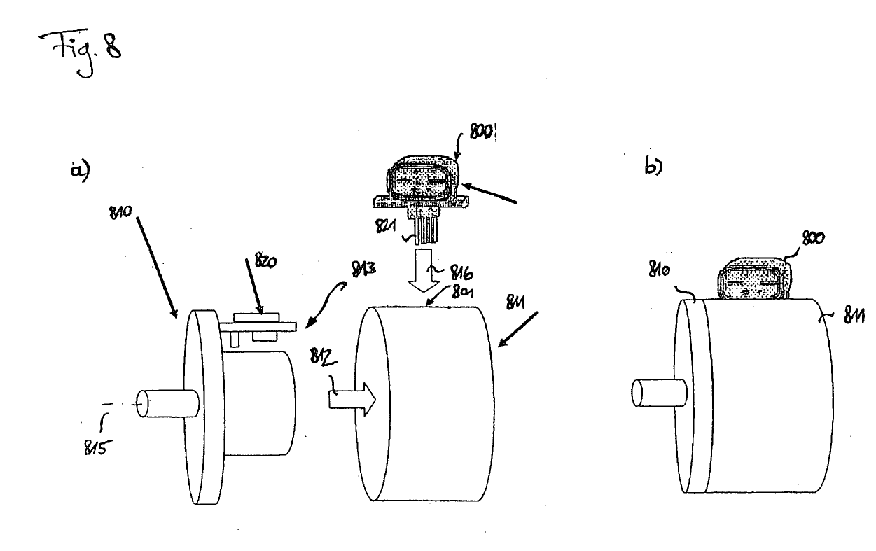

FIGS. 8a and b are outlines showing the mounting of an adapter according to the invention at an angled installation direction in a basic component, in a drive;

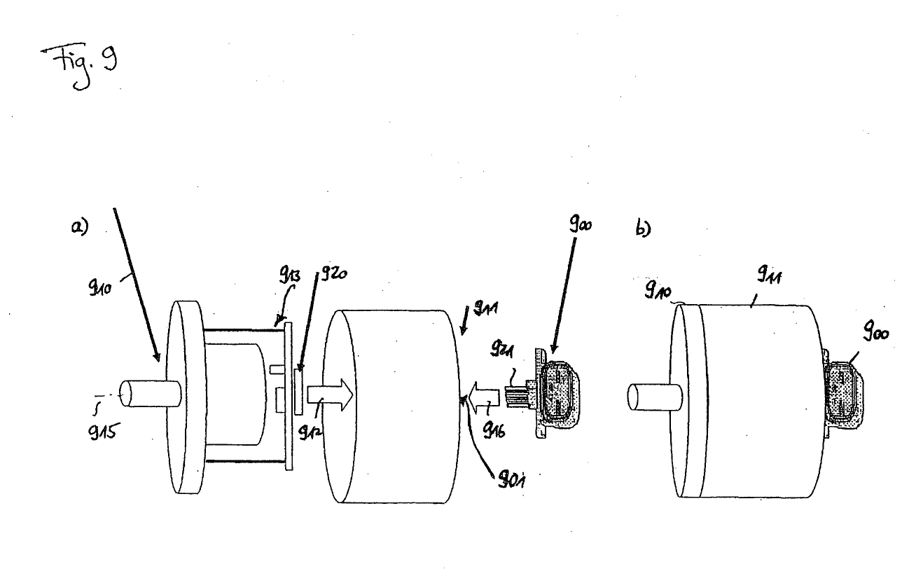

FIGS. 9a and b are outlines showing the mounting of an adapter according to the invention in an opposed installation direction in a basic component, in a drive;

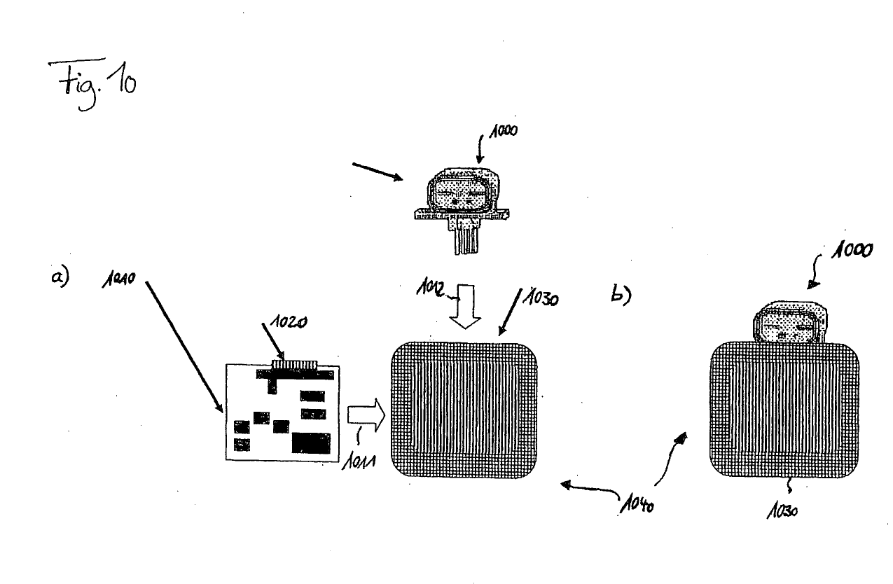

FIGS. 10a and b are outlines showing the mounting of an adapter according to the invention in an angled installation direction in a basic component, into a control device;

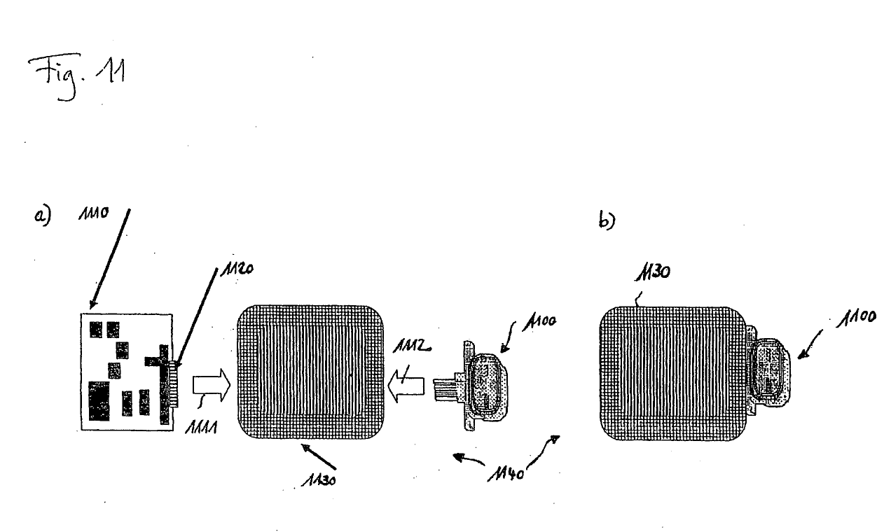

FIGS. 11a and b are outlines showing the mounting of an adapter according to the invention in an opposed installation direction in a basic component, into a control device; and

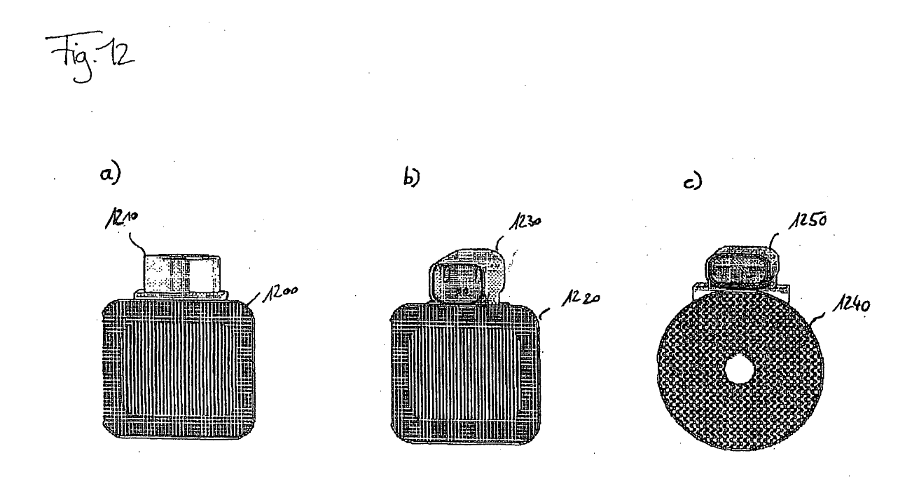

FIGS. 12a to c are outlines with adapters according to the invention which are mounted on control devices and on a drive.

FIGS. 1a to f illustrate various embodiments of a connection adapter according to the invention, referred to below for short as adapter, for connecting at least one basic E/E component, referred to below for short as basic component, to a (vehicle) onboard power system or to a control device.

The illustrated embodiments according to FIGS. 1a to f differ here in the number of E/E components which can be connected in addition to the basic component, in the orientation of the (connection) contacts of the plug-in connections and in the orientation of the plug-in connections or of the connection sides.

FIGS. 1a and b show an embodiment of a connection adapter 100 according to the invention for making contact with or connecting just one basic component to a (vehicle) onboard power system or an actuation device.

In this connection adapter 100—which has 4 poles and with which contact can be made on one side—connection to the onboard power system or actuation device is made by means of a 4 pole onboard power system plug (not illustrated) which can be plugged into the plug-in location 105 provided for it on the connection side of the adapter 100 or of the adapter housing 111, indicated by the arrow 106.

The connection contacts 101 to 104 for making contact with the onboard power system plug, referred to as main current contacts 101 and 102 for connecting a current supply and what are referred to as signal line contacts 103 and 104 for connecting signal lines for the purpose of actuation are arranged horizontally in the case of the adapter 100.

The basic component is connected by the plug-in contacts 107 to 110, which leave the adapter housing 111 in the downward direction, as illustrated on the connection side designated by the arrow 112, said plug-in contacts 107 to 110 forming a continuation of the connection contacts 101 to 104 and thus also having main current contacts 107 and 108 as well as signal contacts 109 and 110.

Since the two connection sides 106 and 112 are arranged in the normal direction with respect to one another, the adapter 100 is what is referred to as an “angled” design.

The adapter housing 111 has, as is shown further by figures la and b, a flange 113 for securing the adapter 100 or the adapter housing 111 to the basic component or to a surface or to the housing of the basic component.

Furthermore, the adapter housing 111 has a hose like encapsulation 114, by injection molding, of the plug-in contacts 107 to 110 which insulates the plug-in connections 107 to 110 from one another in the outward direction, and protects them.

FIG. 1c shows a further embodiment of a connection adapter 100a according to the invention for making contact with or connecting just one basic component to a (vehicle) onboard power system or an actuation device.

In this connection adapter 100a—which also has four poles and with which contact can be made on one side—the connection to the onboard power system or actuation device is also made by means of a four pole onboard power system plug (not illustrated) which can be plugged into the plug-in location 105a provided for it on the connection side of the adapter 100a or of the adapter housing 111a characterized by the arrow 106a.

The basic component is also connected by the plug-in contacts 107a to 110a, which leave the adapter housing 111a in the downward direction, as illustrated on the connection side characterized by the arrow 112a, said plug-in contacts 107a to 110a forming a continuation of the connection contacts 101a to 104a (not visible) and thus also having main current contacts 107a and 108a as well as signal contacts 109a and 110a.

Since both connection sides 106a and 112a are arranged opposite one another (in their extension) the adapter 100a is what is referred to as a “straight” embodiment.

The adapter housing has, as is shown also below by FIG. 1c, a flange 113a for securing the adapter 100a or the adapter housing 111a to the basic component or to a surface or to the housing of the basic component. Furthermore, the adapter housing 111a also has a hose shaped encapsulation 114a, by injection molding, of the plug-in contacts 107a to 110a which insulates the plug-in connections 107a to 110a from one another in the outward direction, and protects them.

FIGS. 1d and e show two embodiments of a connection adapter 100b according to the invention for making contact between or connecting a basic component and an additional E/E component to a (vehicle) onboard power system or an actuation device.

In these connection adapters 100b, which have four poles and with which contact can be made on two sides, the connection to the onboard power system or actuation device is made via a four pole onboard power system plug (not illustrated) which can be plugged into the plug-in location 105b provided for that purpose on the connection side of the respective adapter 100b or of the respective adapter, housing 111b, characterized by the arrow 106b.

The connection contacts 101b to 104b for making contact with the onboard power system plug, referred to as main current contacts 101b and 102b for connecting a power supply and what are referred to as signal line contacts 103b and 104b for connecting signal lines for actuation are arranged vertically in the case of the first adapter 100b according to FIG. 1d and horizontally in the case of the second adapter 100b according to FIG. 1e.

The connection of the basic component is made in each case by means of the plug-in contacts 107b to 110b, which leave the adapter housing 111b in the downward direction as illustrated on the connection side characterized by the arrow 112b, said plug-in contacts 107b to 110b forming a continuation of the connection contacts 101b to 104b and thus also having main current contacts 107b and 108b as well as signal contacts 109b and 110b.

A connection side characterized by the arrow 116b is arranged opposite the connection side 106b in the case of the adapters 100b.

The connection of the additional E/E component (not illustrated) to the adapters 100b and thus to the onboard power system or actuation device is made by means of this connection side 116b or by means of a plug-in location 117b (not visible) provided for this purpose on this connection side 116b. The connection of the additional E/E component is made by means of the connection plug (not illustrated) which also has four poles and which can be plugged in to the plug-in location 117b provided for that purpose.

The adapter housing also has, as is shown by FIGS. 1d and e, a flange 113b for securing the adapter 100b or the adapter housing 111b to the basic component or to a surface or to the housing of the basic component. Furthermore, the adapter housing 111b also has a hose like encapsulation 114b, by injection molding, of the plug-in contacts 107b to 110b which insulates the plug-in connections 107b to 110b from one another in the outward direction, and protects them.

FIG. 1f shows a further embodiment of a connection adapter 100c according to the invention for making contact between or for connecting a basic component and two additional E/E components to a (vehicle) onboard power system or an actuation device.

In this connection adapter 100c, which also has four poles, with which contact can be made on one side and which corresponds essentially to the adapter 100b according to FIG. 1e, the connection of the second additional E/E component is made via a connection plug (not illustrated) which also has four poles and can be plugged in to a plug-in location 118c which is provided for this purpose on the connection side of the adapter 100c or of the adapter housing 111c, characterized by the arrow 119c.

FIG. 2 shows the adapter 200 or 100b in an embodiment according to FIG. 1d in an enlarged illustration.

FIG. 2 thus shows a connection adapter 200 or 100b according to the invention for making contact between or for connecting a basic component and an additional E/E component to a (vehicle) onboard power system or an actuation device in which the main current contacts and signal contacts on the sides connecting to the onboard power system and to the additional E/E component are arranged vertically.

In addition to the components of the adapter 100b which have already been described in conjunction with FIG. 1e, in FIG. 2 an attachment flange 202 with bores and a groove for an O ring which is characterized by an arrow 203 is additionally characterized by an arrow 201.

The attachment flange 202 with the bores, the groove for the O ring and the O ring serve to seal and secure the connection of the adapter 200 to the basic component.

Furthermore, the side connecting to the onboard power system or to the actuation device is designated by an arrow 210, the side connecting to the additional E/E component by an arrow 211, the main current contacts are designated by arrows 212, the signal contacts by arrows 213, the encapsulation of the plug-in contacts by injection molding by an arrow 214 and the plug-in contacts for making contact with the basic component by an arrow 215.

FIGS. 3a and 3b are further illustrations or views of the adapter 300, 200 and, respectively, 100b in an embodiment according to FIG. 1d and according to FIG. 2.

FIGS. 3a and 3b thus also show an inventive connection adapter 300 or 200 or 100b, respectively, for making contact between or for connecting a basic component and an additional E/E component to a (vehicle) onboard power system or an actuation device in which the main current contacts and signal contacts on the sides connecting to the onboard power system and to the additional E/E component are arranged vertically.

In addition to the components of the adapter 100b or 200 which have already been described in conjunction with FIG. 1d and FIG. 2, in FIGS. 3a and 3b an arrow 301 is used to characterize the plug connection of the onboard power system or of the onboard power system plug or of the actuation device, an arrow 302 is used to characterize the plug connection to the additional E/E component, and an arrow 303 is used to characterize the formation of contact or the plug-in contact with the basic component.

In particular, FIGS. 3a and 3b show the attachment flange 310 or 202 with the bores 311 and the groove 312 for the O ring 313 which are used to seal and secure the connection of the adapter 300 to the basic component.

FIGS. 4a and 4b show further illustrations or views of the adapter 400 or 100b in an embodiment according to FIG. 1e.

Thus, FIGS. 4a and 4b also show an inventive connection adapter 400 or 100b for making contact between or for connecting a basic component and an additional E/E component to a (vehicle) onboard power system or an actuation device in which the main current contacts and signal contacts on the sides connecting to the onboard system and to the additional E/E component are arranged horizontally.

In addition to the components of the adapter 100b already described in conjunction with FIG. 1e, in FIGS. 4a and 4b an arrow 401 is used to characterize the plug connection of the onboard power system or of the onboard power system plug or of the actuation device, an arrow 402 is used to characterize the plug connection to the additional E/E component, and an arrow 403 is used to characterize the formation of contact or the plug-in contact to the basic component.

In particular, FIGS. 4a and 4b show the attachment flange 410 with the bores 411 and the groove 412 for the O ring 413 which serve to seal and secure the connection of the adapter 400 to the basic component.

FIGS. 5a and 5b show further illustrations or views of the adapter 500 or 100 in an embodiment according to FIGS. 1a and 1b.

FIGS. 5a and 5b thus show a connection adapter 500 or 100 according to the invention for making contact between or for connecting just one basic component and a (vehicle) onboard power system or an actuation device in which the main current contacts or signal contacts on the side connecting to the onboard power system are arranged horizontally.

In addition to the components of the adapter 100 which have already been described in conjunction with the FIGS. 1a and 1b, in FIGS. 5a and 5b an arrow 501 is used to characterize the plug connection of the onboard power system or of the onboard power system plug or of the actuation device, and an arrow 502 is used to characterize the formation of contact or the plug-in contact to the basic component.

In particular, FIGS. 5a and 5b here also show the attachment flange 510 with the bores 511 and the groove 512 for the O ring 513 which are used to seal and secure the connection of the adapter 500 to the basic component.

FIGS. 6a to 6c show the mounting of an adapter 600 according to the invention, for example according to one of the embodiments designated by 100, 100a to 100c or 200, 300, 400 or 500, in a basic component 610, here in a drive 610.

FIG. 6a shows here the installation region 601 on the basic component in which the adapter 600 is installed.

The installation region comprises, as is shown by FIG. 6a, part of the drive housing 611 on which a connection flange 612 with a breakthrough 613, a groove 614 for an O ring seal 617 for an O ring 615 and attachment holes 616 are arranged.

FIG. 6b shows the mounting process 602 in which the adapter 600 is inserted into the breakthrough 613 in the basic component 610 in the direction 603 of the arrow and with the illustrated orientation.

In this context, the -plug-in contacts 630 of the adapter 600 are pushed through the breakthrough 613.

FIG. 6c shows the adapter 600 which is mounted in the basic component 610.

In the completely mounted state, the connection between the adapter 600 and the basic component 610 has a seal and is secured by virtue of a flange connection 622 composed of the two (connecting) flanges, i.e. the connecting flange of the adapter 612 and the connecting flange of the basic component 620.

The flange connection is secured and sealed here by means of the integrated groove 614 and the O ring 615 inserted into the groove 614 and by an attachment by means of a screwed connection.

In the completely mounted state, the plug-in contacts 630 of the adapter 600 are then arranged within the drive housing 610.

FIGS. 8a and 8b show a further mounting of an adapter 800 according to the invention, for example according to one of the embodiments designated by 100, 100a to 100c or 200, 300, 400 or 500, in a basic component 810, here also in a drive 810.

According to FIGS. 8a and 8b, the adapter 800 is mounted in an angled installation direction (812, 816).

FIG. 8a shows here the opened drive unit 810 with internal (drive) electronics 813. In order to connect the drive 810 to the onboard power system, a basic mating contact base 820, connected to the drive electronics 813, is arranged offset radially outwards in the axial direction with respect to the drive axis 815 on the drive unit 810, as is shown by FIG. 8a.

Arrow 812 characterizes the insertion direction of the opened drive unit 810 into the drive housing 811, in which direction the drive unit 810 is pushed into the housing 811 when it is mounted.

The housing 811 has an installation region 801 (not visible) which is embodied in accordance with the installation region 601 from FIGS. 6a to c and in which the adapter 800 is installed.

When mounting is carried out, the plug-in contacts 821 of the adapter 800 are pushed vertically from above through the housing 811, characterized by arrow 816 in FIG. 8a, and the adapter 800 forms a plug-in connection with the basic mating contact base 820 of the drive unit 810 which is pushed into the housing in the direction of the arrow 812.

Since the insertion direction 816 of the adapter 800 into the housing 811 according to FIG. 8a is arranged in the normal direction with respect to the insertion direction 812 of the drive unit 810 into the housing 811, the mounting is carried out here in an “angled” installation direction.

FIG. 8b shows the drive 810 with the adapter 800 which is mounted on the housing 811.

FIGS. 9a and 9b show further mounting of an adapter 900 according to the invention, for example according to one of the embodiments designated by 100, 100a to 100c or 200, 300, 400 or 500, in a basic component 910, here also in a drive 910.

The mounting of the adapter 900 is carried out this time in an opposed installation direction (912, 916) according to FIGS. 9a and 9b.

FIG. 9a also shows here the opened drive unit 910 with internal (drive) electronics 913. In order to connect the drive 910 to the onboard power system, a basic mating contact base 920, connected to the drive electronics 913, is arranged oriented axially with respect to the drive axis 915 on the drive unit 910, as is shown by FIG. 9a.

Arrow 912 also characterizes the insertion direction of the opened drive unit 910 into the drive housing 911, in which direction the drive unit 910 is pushed into the housing 911 when it is mounted.

The housing 911 has an installation region 901 (not visible) which is also configured in accordance with the installation region 601 from FIGS. 6a to c and in which the adapter 900 is installed.

When mounting is carried out, the plug-in contacts 921 of the adapter 900 are pushed through the housing 911 along the drive axis in the opposite direction to the insertion direction 912 and form a plug-in connection with the basic mating contact base 920 of the drive unit 910 which is pushed into the housing in the direction of the arrow 912.

Since, in this case, the insertion direction 916 of the adapter 900 into the housing 911 according to FIG. 9ais arranged in the opposite direction to the insertion direction 912 of the drive unit 910 into the housing 911, the mounting is carried out here in an “opposed” installation direction.

FIG. 9b shows the drive 910 with the adapter 900 mounted on the housing 911.

In FIGS. 10a and b and in FIGS. 11a and b, the corresponding mounting operations are illustrated for an adapter 1000 or 1100 according to the invention in a control device 1040 or 1140 in the angled installation direction (FIGS. 10a and 10b) and in the opposed installation direction (FIGS. 11a and b) corresponding to the mounting of the inventive adapter in the drive according to FIGS. 9a and b (angled installation direction) and the FIGS. 10a and b (opposed installation direction).

FIG. 10a shows an electronic unit 1010 with the basic mating contact base 1020, which unit 1010 is inserted into the housing 1030 of the control device 1040 in the direction of the arrow 1011. According to FIG. 10a, the adapter 1000 is inserted into the housing 1030 in the direction of the arrow 1012.

FIG. 10b shows the control device with the adapter 1000 mounted on the housing 1030.

FIG. 11a shows an electronic unit 1110 with the basic mating contact base 1120 which is inserted into the housing 1130 of the control device 1140 in the direction of the arrow 1111. According to FIG. 11a, the adapter 1100 is inserted into the housing 1130 in the direction of the arrow 1112.

FIG. 11b shows the control device with the adapter 1000 mounted on the housing 1130.

Outlines with adapters according to the invention which are mounted on control devices and on a drive are illustrated in FIGS. 12a to c.

FIG. 12a shows a control device 1200 with a mounted adapter 1210 with which contact can be made on one side, in a straight design (single plug of straight design). FIG. 12b shows a control device 1220 with a mounted adapter 1230 with which contact can be made on two sides (double plug). FIG. 12c shows a drive 1240 with a mounted adapter 1250 with which contact can be made on two sides (double plug).

1. A device for connecting at least one electrical component to a line network of a motor vehicle:
wherein
the device has a housing in which a first contact unit is arranged on a first side of the housing and a second contact unit is arranged on a second side of the housing,
the line network can be connected to the first contact unit,
the at least one electrical component can be connected to the second contact unit,
the first contact unit is connected to the second contact unit, using at least one contact conductor, in such a way that an electrical line connection can be produced between the line network and the at least one electrical component.

2. The device as claimed in claim 1, wherein the line network can be connected to the first contact unit by means of a plug connection.

3. The device as claimed in claim 1, wherein the line network has a contact plug for connecting to the first contact unit.

4. The device as claimed in claim 1, wherein the first contact unit is part of a plug connection, in particular a plug socket, designed to receive a contact plug.

5. The device as claimed in claim 1, wherein the electrical component can be connected to the second contact unit using a plug connection.

6. The device as claimed in claim 1, wherein in that the electrical component has a plug-in socket, in particular a mating contact base which is integrated into the electrical component, designed to receive plug-in contacts for connecting to the second contact unit.

7. The device as claimed in claim 1, wherein the second contact unit is part of a plug-in connection, in particular an arrangement of a plurality of plug-in contacts, designed to produce a plug-in connection to a mating contact base.

8. The device as claimed in claim 1, wherein means are arranged at least partially on the second side of the housing and/or second contact unit and can be used to seal and/or secure the connection of the electrical component to the second contact unit.

9. The device as claimed in claim 8, wherein the seal is embodied by means of a flange connection with an integrated o ring or a sealing film.

10. The device as claimed in claim 8, wherein the securing connection is configured by means of a screwed connection or a welded connection.

11. The device as claimed in claim 1, wherein a seal and a securing connection are implemented by means of a flange connection which is secured by means of an integrated groove and an O ring inserted in the groove and by attachment by means of a screwed connection.

12. The device as claimed in claim 1, wherein the housing has at least a further, third housing side on which a third contact unit is arranged, to which third contact unit an additional electrical component can be connected.

13. The device as claimed in claim 1, wherein the third contact unit is connected to the first and/or second contact unit, using at least one contact conductor, in such a way that an electrical line connection can be produced between the line network and the additional electrical component and/or the electrical component and the additional electrical component.

14. The device as claimed in claim 1, wherein the additional electrical component can be connected to the third contact unit using a plug-in connection.

15. The device as claimed in claim 1, wherein the third contact unit is part of a plug connection, in particular a plug socket, designed to receive a contact plug.

16. The device as claimed in claim 1, wherein the first contact unit and the second contact unit and/or the first contact unit and the third contact unit are oriented in a normal direction with respect to one another or opposite one another.

17. The device as claimed in claim 1, wherein the housing has at least two such third housing sides, on each of which such a third contact unit is arranged, for connecting at least two additional electrical components.

18. The device as claimed in claim 1, wherein the electrical component is an electric drive, a blower regulator or an electric control unit.

19. The device as claimed in claim 1, wherein the housing can be manufactured by encapsulation by injection molding of the contact conductor or conductors.

20. The device as claimed in claim 1, wherein the contact conductor or conductors are flat conductors or round conductors.

21. The device as claimed in claim 1, wherein the contact units each have a plurality of contacts which are arranged horizontally and/or vertically, in particular main current contacts and/or signal contacts.

22. The device as claimed in claim 1, wherein the motor vehicle is a passenger car, a sports utility vehicle, a motorbike or a truck.
